(19) United States
(12) Patent Application Publication
(10) Pub. No.: US 2026/0065642 A1
(43) Pub. Date: Mar. 5, 2026

(54) DECORRELATED TOPIC BASED REPRESENTATION OF ROAD ELEMENTS FOR CLASSIFICATION

(71) Applicant: AUTOBRAINS TECHNOLOGIES LTD, Tel Aviv-Yafo (IL)

(72) Inventors: Leah BAR, Tel Aviv-Yafo (IL); Lior ELDAR, Tel Aviv-Yafo (IL)

(73) Assignee: AUTOBRAINS TECHNOLOGIES LTD, Tel Aviv-Yafo (IL)

(21) Appl. No.: 18/824,937

(22) Filed: Sep. 5, 2024

(51) Int. Cl. G06V 10/764; G06V 20/56

(52) U.S. Cl. CPC G06V 10/764; G06V 20/588

(57) ABSTRACT

A method decorrelated topic based representation of road elements for classification, the method includes obtaining, at a machine learning process, a sparse binary representation corresponding to an initial embedding space of a road element captured in a sensed information unit; and selecting, by checking values of topic information of the sparse binary representation using the machine learning process, a topic, from a set of topics respectively characterized in the initial embedding space, the selected topic corresponding to a reduced space, each of the selected set of topics determined in decorrelation from another topic based on at least in part a measurement of an entropy distribution of bits of the sparse binary representation.

### BACKGROUND

Vehicles with autonomous driving capabilities and/or driver assistance capabilities are required to process in real time information regarding one or more road elements and to respond accordingly.

There is a growing need to improve the processing of information regarding road elements.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates an example of a vehicle;

FIG. 2 illustrates an example of a method;

FIG. 3 illustrates an example of a method;

FIG. 4 illustrates examples of a sparse binary representation and other data elements.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

According to an embodiment, a road element is sensed by a sensing unit associated with a vehicle to provide a sensed information unit. The sensed information unit is processed by a machine learning process to provide a high dimensional sparse binary representation of the road element.

The high dimensional sparse binary representation may include thousands of bits and even tens of thousands of bits—which greatly increase the memory and processing resources allocated for processing the sparse binary representation during a classification process.

According to an embodiment, the classification process is required to associate the road element with a topic out of set of topics. The number of topics is much smaller than the number of bits of the sparse binary representation.

According to an embodiment, there is provided a method that associates the road element to a topic by processing only a small fraction of the high dimensional sparse binary representation.

According to an embodiment, during a learning process, for each topic of the set of topics, topic information is found within the high dimensional sparse binary representation is detected, so that topic information related to different topics are decorrelated.

According to an embodiment, the size of each topic information is a first fraction of the size of the high dimensional sparse binary representation—and given the limited number of topics (for example a second fraction of the size of the high dimensional sparse binary representation)—the processing and storage resources required for classification is less than a third fraction of the size of the high dimensional sparse binary representation. The first fraction, the second fraction and the third fraction may be, for example, less than 0.1, 0.5, 1, 2 or 5 percent of the size of the high dimensional sparse binary representation. According to an embodiment, the third fraction is of the order of the product of multiplication of the second fraction by the third fraction.

According to an embodiment the number of topics ranges between 2 and 100, the number of bits per topic information ranges between 4 and 50, and the like. Other values may be provided.

According to an embodiment, the learning process includes applying correlation explanation. Correlation explanation is designed for unsupervised learning and explainable data mining. It is used to discover patterns and structure in data without needing labeled outcomes. It utilizes principles from information theory, particularly total correlation, to measure how much information is shared among variables. The correlation explanation identifies latent factors or topics that explain the observed correlations in the data. These latent factors help to summarize and describe the data more compactly. Correlation explanation minimizes the total correlation, which is a measure of the redundancy in a set of variables. By finding latent factors that reduce this redundancy, the algorithm can uncover meaningful patterns.

According to an embodiment, the correlation explanation creates a hierarchical structure of latent factors, where higher-level factors summarize groups of lower-level factors. This hierarchy can provide a multi-level explanation of the data. See, for example, “Discovering structure in high-dimensional data through correlation explanation”, Greg Ver Steeg, Aram Galsyman, arXiv: 1406, 1222v2 [cs.LG] 31 Oct. 2014, which is incorporated herein by reference.

According to an embodiment, the total correlation process reduced the dependency between topic information of different topics. Total correlation is (in probability theory and in particular in information theory) one of several generalizations of the mutual information. It is also known as the multivariate constraint or multi-information It quantifies the redundancy or dependency among a set of n random variables. Total correlation measures the difference between the sum of the individual entropies of a set of variables and the joint entropy of those variables.

Mathematically, for a set of random variables X1, X2, . . . , Xn, the total correlation C(X1, X1, . . . , X_n) is given by C(X1, X2, . . . Xn)=sum(H(Xi))−H(x1, X2, . . . Xn). The total correlation uses an optimization process to find the best set of latent factors that minimize the total correlation in the data.

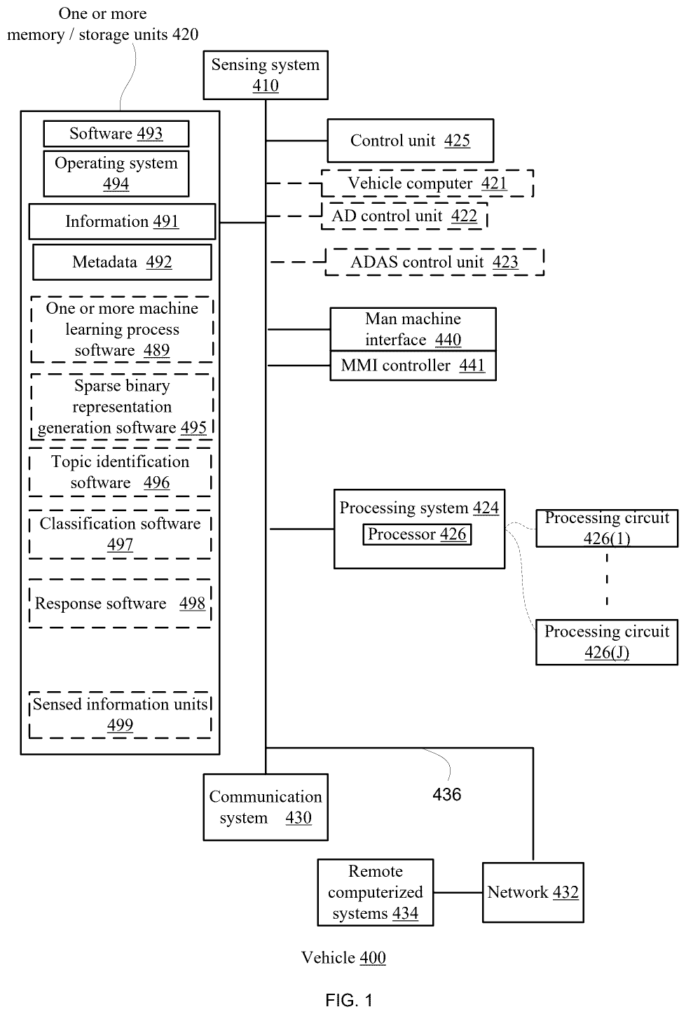

FIG. 1 illustrates an example of a vehicle 400.

Vehicle 400 includes a man machine interface 440 having or being in communication with man machine interface (MMI) controller 441, a communication system 430, one or more memory and/or storage units 420, a processing system 424 including processor 426. The communication system 430, the one or more memory and/or storage units 420, and the processing system 424 may belong to a computerized system of vehicle 400. The computerized system may be a server, a laptop, a desktop or any other computer and may include or be in communication with a sensing unit and/or a controller.

According to an embodiment, vehicle 400 is in communication with network 432 and one or more other remote computerized systems 434 that are in communication with network 432. An example of a remote computerized system is a server or one or more computers having access to a storage system that stores items related to one or more portions of one or more groups of neural networks—at least some of which are not currently stored in the vehicle.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as sensing system 410, man machine interface 440, control unit 425, vehicle computer 421, autonomous driving control unit 422 (denoted AD control unit), advanced driver assistance system (ADAS) control unit 423 (denoted ADAS control unit), and the like.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 494, information 491 such as sensed information units 499, metadata 492, and software 493 such as sparse binary representation generation software 495, topic identification software 496, classification software 497, response software 498, one or more machine learning process software 489) for executing method 200. The response software 498 is for responding to a classification decision—for example by generating a driving related output.

The control unit 425 may cooperate with ADAS control unit 423 and/or with AD control unit 422 and/or may control or communicate with other vehicle components-including vehicle computer.

The ADAS control unit 423 is configured to control ADAS operations.

The AD control unit 422 is configured to control autonomous driving of the autonomous vehicle.

The vehicle computer 421 is configured to control the operation of the vehicle—especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

Control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 alone or in combination of any other unit illustrated above, is configured to perform, while executing software or method 200.

According to an embodiment, processing system 424 alone or in combination of any other unit illustrated above, is configured to:
A. Obtain, at a machine learning process implemented by the processing system, a sparse binary representation corresponding to an initial embedding space of a road element captured in a sensed information unit.
B. Selecting, by checking values of topic information of the sparse binary representation using the machine learning process, a topic associated with the spare binary representation, from a set of topics respectively characterized in the initial embedding space, the selected topic corresponding to a reduced space, each of the selected set of topics determined in decorrelation from another topic based on at least in part a measurement of an entropy distribution of bits of the sparse binary representation.
C. Determine, using the selected topic, a topic based representation of the road element for classification.
D. Classify the road element in accordance with the topic.
E. Generate, based on a classification of the road element, a driving related output with respect to the vehicle.

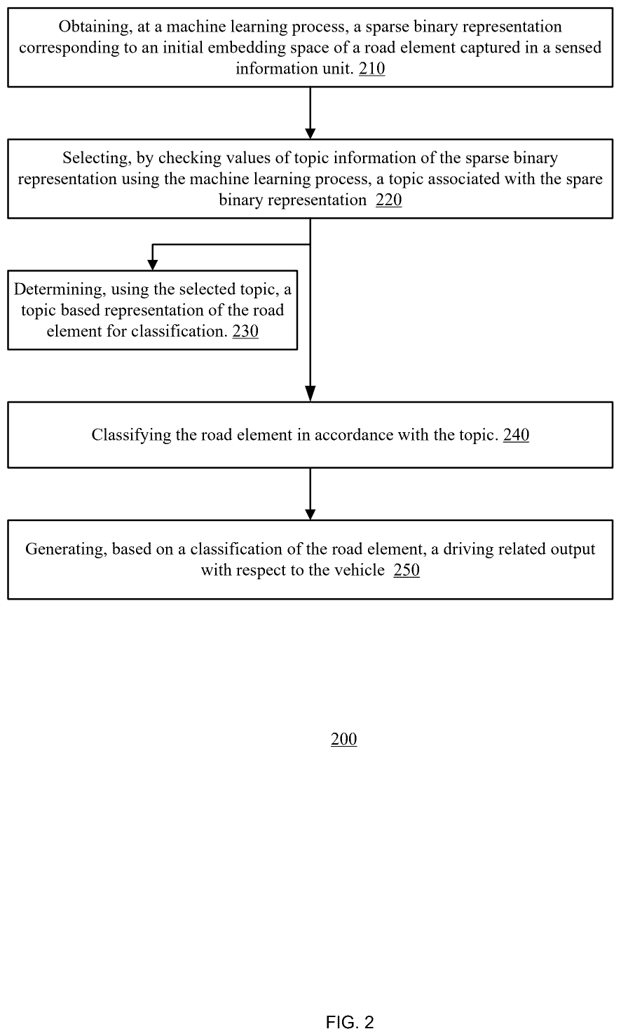

FIG. 2 illustrates an example of method 200 of decorrelated topic based representation of road elements for classification.

According to an embodiment, method 200 includes step 210 of obtaining, at a machine learning process, a sparse binary representation corresponding to an initial embedding space of a road element captured in a sensed information unit. The dimension of the initial embedding space is determined by the size of the sparce binary representation and may exceed one thousand, ten thousands and the like.

According to an embodiment, step 210 is followed by step 220 of selecting, by checking values of topic information of the sparse binary representation using the machine learning process, a topic associated with the spare binary representation, from a set of topics respectively characterized in the initial embedding space, the selected topic corresponding to a reduced space, each of the selected set of topics determined in decorrelation from another topic based on at least in part a measurement of an entropy distribution of bits of the sparse binary representation.

The set of topics are respectively characterized in the initial embedding space in the sense that each topic is associated with topic information that includes bits within he sparce binary representation.

The selected topic corresponding to a reduced space in the sense that the size of the topic information associated with each topic is much smaller than the size of the sparse binary representations.

According to an embodiment, the set of topics are determined by applying an entropy based unsupervised learning process.

According to an embodiment, the set of topics are determined by applying a learning process that includes applying correlation explanation. Correlation explanation is designed for unsupervised learning and explainable data mining. It is used to discover patterns and structure in data without needing labeled outcomes. It utilizes principles from information theory, particularly total correlation, to measure how much information is shared among variables. The correlation explanation identifies latent factors or topics that explain the observed correlations in the data. These latent factors help to summarize and describe the data more compactly. Correlation explanation minimizes the total correlation, which is a measure of the redundancy in a set of variables. By finding latent factors that reduce this redundancy, the algorithm can uncover meaningful patterns.

According to an embodiment, the correlation explanation creates a hierarchical structure of latent factors, where higher-level factors summarize groups of lower-level factors.

According to an embodiment, the total correlation process reduces the dependency between topic information of different topics. Total correlation is (in probability theory and in particular in information theory) one of several generalizations of the mutual information. It is also known as the multivariate constraint or multi-information It quantifies the redundancy or dependency among a set of n random variables. Total correlation measures the difference between the sum of the individual entropies of a set of variables and the joint entropy of those variables.

According to an embodiment, step 220 includes exclusively determining an association for the selected topic. The association is between the road element and one of the set of topics.

According to an embodiment, step 220 includes determining a probability of an association for the selected topic.

According to an embodiment, step 220 includes determining of the probability based on topic rules that associate a probability for matches and partial matches between the values of the topic information of the sparse binary representation and expected values of the topic information.

According to an embodiment, per topic the topic information includes a group of topic bits of the sparse binary representation of a certain value (for example—set bits). Different topics are associated with different groups of topic bits.

Assuming that the selected bits are expected to be set, step 220 include comparing a group of topic bits of a sparse binary representation to reference group in which all the topic bits are set—to provide comparison result. The comparison results indicate which topic bits of the group are set—and may be indicative of a full match (all bits of the group are set), a partial match (only some of the topic bits of the group are set) or a mismatch (all bits of the group are reset).

According to an embodiment, the learning provides a probability of association of the road element to the topic-per each outcome of the comparison result.

According to an embodiment, the association of the road element to each of the topics of the set of topics is evaluated to provide a set of probabilities-one probability per each topic.

According to an embodiment, step 220 is followed by step 230 of determining, using the selected topic, a topic based representation of the road element for classification.

According to an embodiment, step 220 is followed by step 240 of classifying the road element in accordance with the topic.

According to an embodiment, a classification decision is made based on the set of probabilities—to associate the road element to one of the topics.

According to an embodiment the sparse binary representation may be associated with more than a single topic—which may indicate that the sparse binary representation represents more than a single road element—or that a classification error has occurred.

According to an embodiment, method 200 further includes selecting another topic, from the set of topics, for classification of another road element.

According to an embodiment, step 240 is followed by step 250 of generating, based on a classification of the road element, a driving related output with respect to the vehicle.

According to an embodiment, the driving related output includes at least one of:
A. An instruction executable by a man machine interface controller, to provide a recommendation to a driver regarding a navigation of the vehicle.
B. A request aimed to the man machine interface controller, to provide a recommendation to a driver regarding a navigation of the vehicle.
C. An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
D. A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
E. An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
F. A request aimed to a driver assistance control unit (such as but not limited to an ADAS control unit) of the vehicle to perform a driver assisting operation-such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
G. An instruction executable by a computer vehicle related to a manner of operation of any component of the vehicle such as brakes, engine, and the like.
H. A request sent to a computer vehicle related to a manner of operation of any component of the vehicle such as brakes, engine, and the like.
I. Information about the environment of the vehicle.
J. A prediction of a future path of the vehicle.
K. A prediction of a behavior of one or more road element.
L. An emergency alert.
M. A collision alert.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment—and/or in the environment with re to the vehicle, an operation and/or response in compliant with one or more levels of autonomous driving—such as L2, L2+, L2++, L3 or L4 autonomous driving.

The providing may include storing at a location accessible to another unit controller, transmitting the instructions to the other unit, sending an indication about the generation of the instructions to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

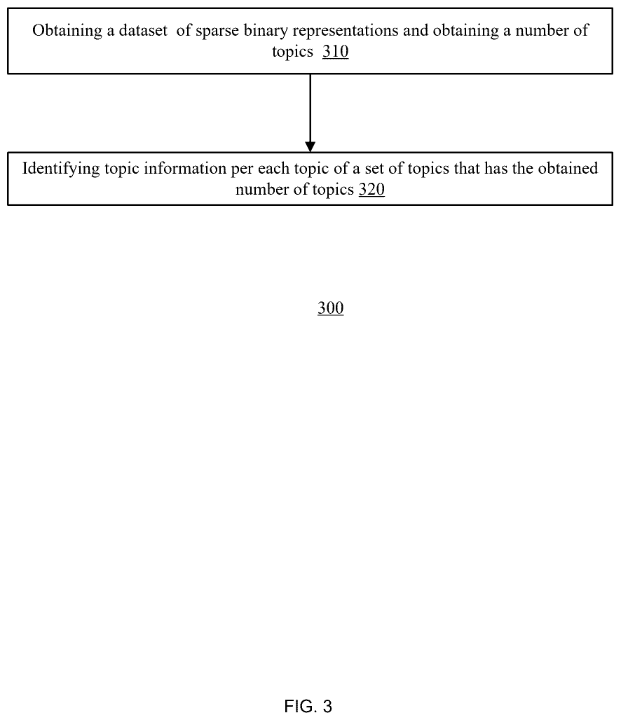

FIG. 3 illustrates method 300 for determining topic related information.

According to an embodiment, method 300 start by step 310 of obtaining a dataset of sparse binary representations and obtaining a number of topics.

According to an embodiment, the dataset is associated with a certain type of road element—for example a vehicle, a vehicle of a class (for example 2 wheeled vehicle, 4 wheeled vehicle, truck, bus, private vehicle, motorcycle, bicycles, scooters), a pedestrian and the like. In this case method 300 may be repeated more than once—for different types of road users.

According to an embodiment the dataset is associated with multiple types of road elements—for example both pedestrians and vehicle, vehicle of different classes, and the like.

According to an embodiment, step 310 is followed by step 320 of identifying topic information per each topic of a set of topics that has the obtained number of topics.

According to an embodiment, step 320 includes applying an entropy based unsupervised learning process.

According to an embodiment, step 320 includes applying correlation explanation. Correlation explanation is designed for unsupervised learning and explainable data mining. It is used to discover patterns and structure in data without needing labeled outcomes. It utilizes principles from information theory, particularly total correlation, to measure how much information is shared among variables. The correlation explanation identifies latent factors or topics that explain the observed correlations in the data. These latent factors help to summarize and describe the data more compactly. Correlation explanation minimizes the total correlation, which is a measure of the redundancy in a set of variables. By finding latent factors that reduce this redundancy, the algorithm can uncover meaningful patterns.

According to an embodiment, the correlation explanation creates a hierarchical structure of latent factors, where higher-level factors summarize groups of lower-level factors.

According to an embodiment, the total correlation process reduced the dependency between topic information of different topics. Total correlation is (in probability theory and in particular in information theory) one of several generalizations of the mutual information. It is also known as the multivariate constraint or multi-information It quantifies the redundancy or dependency among a set of n random variables. Total correlation measures the difference between the sum of the individual entropies of a set of variables and the joint entropy of those variables.

According to an embodiment, step 320 also include calculating probabilities of association of topic information of different topics to the different topics.

According to an embodiment the determining of the probability is based on topic rules that associate a probability for matches and partial matches between the values of the topic information of the sparse binary representation and expected values of the topic information.

According to an embodiment, the probabilities are generated by applying the at least one of the entropy based unsupervised learning process, correlation explanation or total correlation.

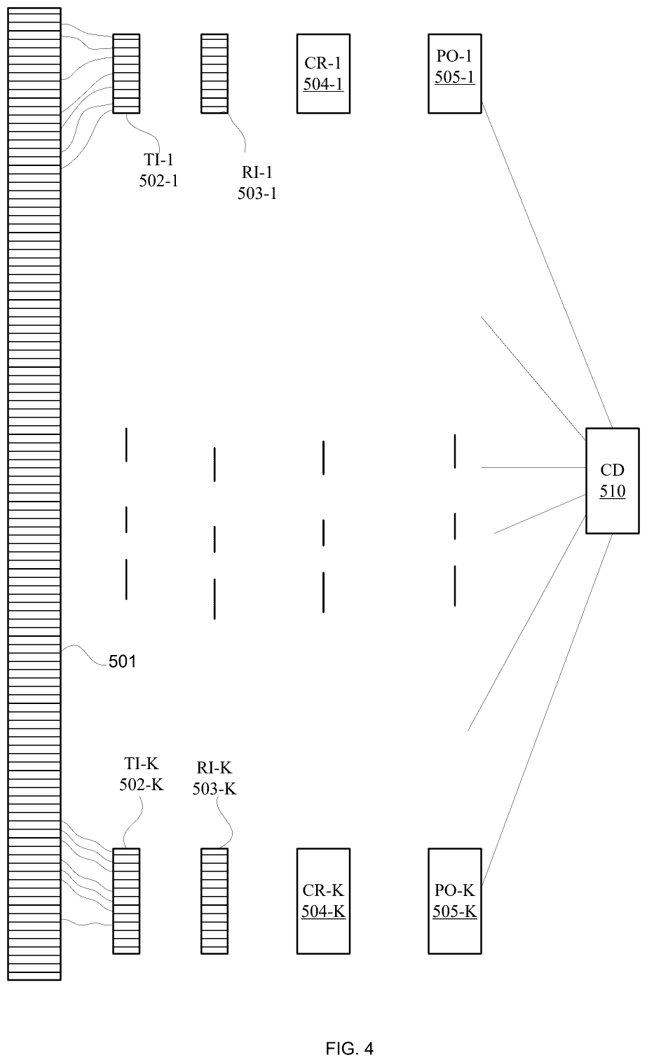

FIG. 4 illustrates an example of a sparse binary representation 501, topic information TI-1-TI-K 502-1-502-K of the sparse binary representation, reference topic information RI-1-RI-K 503-1-503-K, comparison results CR-1-CR-K 504-1-504-K, probabilities of associations PA-1-PA-K 505-1-505-K related to the probability of having the sparse binary representation associated with the K topics, and a classification decision CD 510.

For example—assuming that a sensed information unit captured a pedestrian of associated with a certain topic, and that the sensed information unit (or cropped sensed information unit consisting essentially of the pedestrian) is processed to provide sparse binary representation. The topic information associated with certain topic is TI-1 and than TI-1 consists of seven bits—bits 5, 20, 45, 101, 150, 210 and 566 of sparse binary representation 501. RI-1 includes seven set bits (at the 5th, 20th, 45th, 101st, 150^{th} and 210^{th} positions).
The reference topic information RI-1 includes a group of set bits (for example—bits 5, 20, 45, 101, 150, 210 and 566 of sparse binary representation 501

The following table provides the PA-1 probabilities of association to the certain topic:

| | Probability of |
|---|---|
| Comparison result (which bits are set) | association |
| All bits are set | P1 |
| Six bits are set - except bit 5 | P2 |
| Six bits are set - except bit 20 | |
| . | |
| . | |
| . | |
| Five bits are set - except bits 5 and 20 | P11 |
| Five bits are set - except bits 20 and 45 | P12 |
| . | |
| . | |
| . | |
| Only bit 5 is set | P61 |
| Only bit 45 is set | P62 |
| Only bit 566 is set | P63 |
| All bits are reset | P71 |

Any combination of any step of any method illustrated in the application is provided.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The vehicle may be any type of vehicle—such as a ground transportation vehicle, an airborne vehicle, or a water vessel.

The specification and/or drawings may refer to an image. An image is an example of sensed information. Any reference to an image may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry (also referred to as a processing circuit). The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The sensed information unit may be sensed by one or more sensors of one or more types. The one or more sensors may belong to the same device or system—or may belong to different devices of systems.

We claim:

1. A method of decorrelated topic based representation of road elements for classification, the method comprising:
obtaining, at a machine learning process, a sparse binary representation corresponding to an initial embedding space of a road element captured in a sensed information unit; and
selecting, by checking values of topic information of the sparse binary representation using the machine learning process, a topic associated with the sparse binary representation, from a set of topics respectively characterized in the initial embedding space, the selected topic corresponding to a reduced space, each of the selected set of topics determined in decorrelation from another topic based on at least in part a measurement of an entropy distribution of bits of the sparse binary representation.

2. The method according to claim 1, further comprising determining, using the selected topic, a topic based representation of the road element for classification.

3. The method according to claim 1, further comprising classifying the road element in accordance with the topic.

4. The method according to claim 3, further comprising generating, based on the classifying of the road element, a driving related output with respect to a vehicle.

5. The method according to claim 1, further comprising selecting another topic, from the set of topics, for classification of another road element.

6. The method according to claim 1, further comprising exclusively determining an association for the selected topic.

7. The method according to claim 1, further comprising determining a probability of an association for the selected topic.

8. The method according to claim 7, wherein the determining of the probability is based on topic rules that associate a probability for matches and partial matches between the values of the topic information of the sparse binary representation and expected values of the topic information.

9. The method according to claim 1, further comprising applying an entropy based unsupervised learning process for learning the entropy distribution of the sparse binary representation.

10. The method according to claim 1, further comprising identifying the set of topics by applying a total correlation process.

11. A non-transitory computer readable medium for decorrelated topic based representation of road elements for classification, the non-transitory computer readable medium stores instructions executable by a processing circuit for:
obtaining, at a machine learning process, a sparse binary representation corresponding to an initial embedding space of a road element captured in a sensed information unit;
selecting, by checking values of topic information of the sparse binary representation using the machine learning process, a topic, from a set of topics respectively characterized in the initial embedding space, the selected topic corresponding to a reduced space, each of the selected set of topics determined in decorrelation from another topic based on at least in part a measurement of an entropy distribution of bits of the sparse binary representation; and
determining, using the selected topic, a topic based representation of the road element for classification.

12. The non-transitory computer readable medium according to claim 11, further storing instructions executable by the processing circuit for determining, using the selected topic, a topic based representation of the road element for classification.

13. The non-transitory computer readable medium according to claim 11, further storing instructions executable by the processing circuit for classifying the road element in accordance with the topic based representation.

14. The non-transitory computer readable medium according to claim 11, further storing instructions executable by the processing circuit for generating, based on a classification of the road element, a driving related output with respect to a vehicle.

15. The non-transitory computer readable medium according to claim 11, further storing instructions executable by the processing circuit for selecting another topic, from the set of topics, for classification of another road element.

16. The non-transitory computer readable medium according to claim 11, further storing instructions executable by the processing circuit for exclusively determining an association for the selected topic.

17. The non-transitory computer readable medium according to claim 11, further storing instructions executable by the processing circuit for determining a probability of an association for the selected topic.

18. The non-transitory computer readable medium according to claim 17 wherein the determining of the probability is based on topic rules that associate a probability for matches and partial matches between the values of the topic information of the sparse binary representation and expected values of the topic information.

19. The non-transitory computer readable medium according to claim 11, further storing instructions executable by the processing circuit for applying an entropy based unsupervised learning process for learning the entropy distribution of the sparse binary representation.

20. The non-transitory computer readable medium according to claim 11, further storing instructions executable by the processing circuit for identifying the set of topics by applying a total correlation process.
